(19) United States
(12) Patent Application Publication
(10) Pub. No.: US 2007/0132383 A1
(43) Pub. Date: Jun. 14, 2007

(54) Plasma display panel

(76) Inventors: Jeong-Nam Kim, Suwon-si (KR); Hyea-Weon Shin, Suwon-si (KR); Young-Do Choi, Suwon-si (KR); Myoung-Sup Kim, Suwon-si (KR); Won-Seok Yoon, Suwon-si (KR); Tae-Jung Chang, Suwon-si (KR); Tae-Seung Cho, Suwon-si (KR); Yong-Shik Hwang, Suwon-si (KR)

Correspondence Address: Robert E. Bushnell, Suite 300, 1522 K Street, N.W., Washington, DC, 20005, US

(21) Appl. No.: 11/635,671

(22) Filed: Dec. 8, 2006

(30) Foreign Application Priority Data
Dec. 8, 2005 (KR) 10-2005-0119490

(51) Int. Cl. H01J 1/62

(52) U.S. Cl. 313/512

(57) ABSTRACT

A plasma display panel is provided. The plasma display panel includes a first substrate, a second substrate facing the first substrate, a plurality of discharge cells which are formed by partitioning a space between the first and second substrates, a plurality of address electrodes which are formed on the first substrate to extend in a first direction, a plurality of first and second electrodes which are formed on the first substrate to extend in a second direction perpendicular to the first direction. The first and second electrodes being electrically separated from the address electrodes and facing each other with the discharge cells interposed therebetween.

### CLAIMS OF PRIORITY

This application makes reference to, incorporates the same herein, and claims all benefits accruing under 35 U.S.C. §119 from an application for PLASMA DISPLAY PANEL earlier filed in the Korean Intellectual Property Office on 8 Dec. 2005 and there duly assigned Serial No. 10-2005-0119490.

### BACKGROUND OF THE INVENTION

1. Field of the Invention

The present invention relates to a plasma display panel, and more particularly, to a plasma display panel having an opposite-discharge electrode structure capable of improving discharge efficiency and production yield.

2. Description of the Related Art

In general, a plasma display panel uses a vacuum ultra violet (VUV) ray emitted from plasma generated through a gas discharge so as to excite a phosphor material. The excited phosphor material generates red (R), green (G), and blue (B) visible beams, so that an image can be displayed.

A plasma display panel can achieve a very large screen, greater than 60 inches, with a small thickness, less than 10 cm. The plasma display panel is a self emission device like a CRT, its color reproduction is excellent, and distortion caused by a viewing angle does not exist. Further, the manufacturing process of the plasma display panel is simpler than a liquid crystal display (LCD), providing a merit in terms of productivity and cost competitiveness. Therefore, the plasma display panel is highly expected as a next generation flat panel display for applications of home appliance television sets.

One example of the plasma display panel is an AC type three-electrode surface discharge plasma display panel. The AC type three-electrode surface discharge plasma display panel includes a first substrate, a second substrate spaced apart from the first substrate by a predetermined distance, and a discharge space formed between the first substrate and the second substrate. Display electrodes, such as sustain electrodes and scan electrode, are formed on a surface of the first substrate. Address electrodes are formed on a surface of the second substrate in a direction perpendicular to the display electrodes. The discharge space is sealed by a sealant applied along edges of the first and second substrates, and a discharge gas is filled in the discharge space. A plurality of discharge cells, which is a basic unit for displaying an image, is provided inside the discharge space by dividing the discharge space.

In the plasma display panel, whether a discharge cell is to be discharged is determined by an address discharge, which is generated by applying voltage between an address electrode and a scan electrode that corresponds to the discharge cell. An image display is achieved during a sustain discharge, which is generated by applying voltage between a sustain electrodes and a scan electrodes of the discharge cell.

Since the scan electrodes and the address electrodes are disposed on the first substrate and on the second substrate, respectively, which are spaced apart from each other, the distance for the address discharge between the substrates is pretty large: Therefore, there is a problem that power consumption for the address discharge increases.

In order to display a large amount of information, plasma display panels having high resolution and highly fine structure have been developed. Accordingly, in order to increase the number of electrodes, which determined the number of pixels, an interval between adjacent electrodes is designed to be short, and a width of each electrode are designed to be small. A plasma display panel, however, normally has thick electrodes, and as a width of each electrode becomes smaller, the chance of producing broken electrodes, which is called “open phenomenon,” increases. As a result, there is a problem that a ratio of defective products greatly increases.

In addition, since the address electrodes and the display electrodes are disposed on the different substrates, ports for supplying driving voltages to the electrodes are also disposed on the different substrates. Therefore, the number of processes necessary to manufacture the plasma display panel increases. As a result, there is a problem that productivity decreases.

### SUMMARY OF THE INVENTION

The present invention provides a plasma display panel having an opposite-discharge electrode structure capable of improving discharge efficiency and production yield.

According to one aspect of the present invention, there is provided a plasma display panel including a first substrate, a second substrate facing the first substrate, a plurality of discharge cells which are formed by partitioning a space between the first and second substrates, a plurality of address electrodes which are formed on the first substrate to extend in a first direction, a plurality of first and second electrodes which are formed on the first substrate to extend in a second direction that is perpendicular to the first direction, a first port formed on a first edge of the first substrate and being connected to the first electrodes, a second port formed on a second edge of the first substrate and being connected to the second electrodes, an address port formed on a third edge of the first substrate and being connected to the address electrodes; and red, green, blue phosphor layers which are formed in the discharge cells. Each of the first electrodes faces one of the second electrodes, and one of the discharges cells is disposed between the first electrodes and the second electrodes.

The second substrate can be disposed so that at least three edges of the first substrate are exposed beyond the second substrate.

In the above aspect of the present invention, the address port can be formed on at least one of two edges of the first electrode in the first direction. The first and second ports can be formed on one edge of the first substrate in the second direction.

The ports can be made of one selected from Cr/Cu/Cr, Cr/Al, Cr/Al/Cr, and MIHL (metal insulator hybrid layer). The address electrodes can be formed to have the same thickness as the address port. The address electrodes can be formed of one selected from Cr/Cu/Cr, Cr/Al, Cr/Al/Cr, and MIHL.

Each of the address electrodes can includes a black layer which is stacked on the first substrate, and a white layer which is stacked on the black layer.

Each of the address electrodes may includes an extension which is disposed to extend in the first direction; and protrusions which are disposed to protrude from the extension in the second direction corresponding to the discharge cells.

A width of the protrusion corresponding to the blue discharge cell may be larger than those of the protrusions corresponding to the red and green discharge cells. A thickness of each of the first and second electrodes may be larger than those of the ports.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view showing a plasma display panel constructed as an embodiment of the present invention;

FIG. 2 is a partially exploded perspective view showing a display region of the plasma display panel shown in FIG. 1;

FIG. 3 is a plan view showing an array of discharge cells and address electrodes shown in FIG. 2;

FIG. 4 is a side cross-sectional view taken along line IV-IV of FIG. 2;

FIG. 5 is a plan cross-sectional view taken along line V-V of FIG. 1;

FIG. 6 is a side cross-sectional view taken along line VI-VI of FIG. 5; and

FIG. 7 is a plan view showing the plasma display panel where a dielectric layer is removed along line VII-VII of FIG. 6.

### DETAILED DESCRIPTION OF THE INVENTION

Hereinafter, exemplary embodiments of the present invention will be described in detail with reference to the attached drawings so that the present invention can be easily applied into practice by those skilled in the art. However, the present invention is not limited to the exemplary embodiments, but can be embodied in various forms. For clarifying of the present invention, description of some constructions and elements not directly related to the present invention is omitted, and like reference numerals denote like elements.

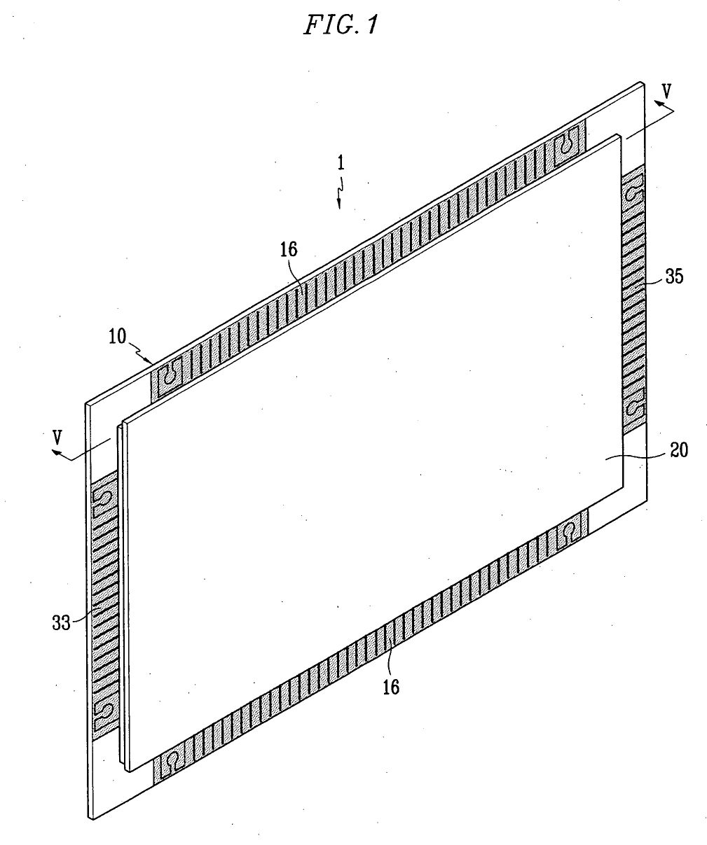

FIG. 1 is a perspective view showing plasma display panel 1 constructed as an embodiment of the present invention. Referring to FIG. 1, the plasma display panel of the embodiment of the present invention includes first substrate 10 (hereinafter, referred to as a front substrate) and second substrate 20 (hereinafter, referred to as a rear substrate) which are facing first substrate 10 and spaced apart from first substrate 10 with a distance. First substrate 10 and second substrate 20 are sealed together to enclose a discharge space formed between first substrate 10 and second substrate 20. An inner surface of first substrate 10 is defined as a surface that faces second substrate 20, and an inner surface of second substrate 20 is defined as a surface that faces the inner surface of first substrate 10.

In the structure shown in FIG. 1, second substrate 20 is assembled with first substrate 10 in a manner that four edges of the inner surface of first substrate 10 are exposed. However, the present invention is not limited to this structure. It is also possible to arrange second substrate 20 in a manner that at least three edges of the inner surface of first substrate 10 are exposed. Address port 16, first (sustain) port 33, and second (scan) port 35 are formed on a third edge, on a first edge, and on a second edge of the exposed inner surface of front substrate 10, respectively, to apply driving pulses, which required to drive plasma discharges, to plasma display panel 1. A display region which displays an image, a dummy region, a redundant region, and a port connection region are provided in a space formed between the first substrate 10 and second substrate 20.

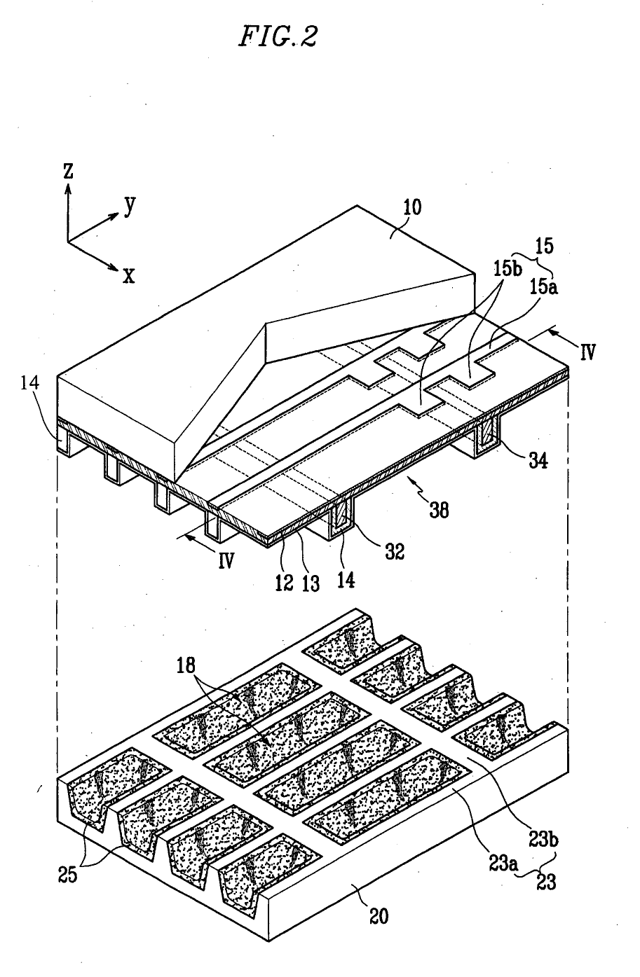

FIG. 2 is a partially exploded perspective view showing a display region of the plasma display panel shown in FIG. 1. Referring to FIG. 2, a plurality of discharge cells 18 are formed by partitioning discharge space 38 formed between first substrate 10 and second substrate 20. Discharge cells 18 can be formed by patterning a dielectric layer (not shown) formed on rear substrate 20 to make partitions. Alternatively, as shown in FIG. 2, discharge cells 18 can be formed by forming barrier rib 23 as partitions. Barrier ribs 23 are formed by etching rear substrate 20.

Barrier rib 23 includes first barrier ribs 23a which are disposed to extend in a first direction (along Y-axis), and second barrier ribs 23b which are disposed to extend in a second direction (along X-axis), which is perpendicular to the first direction. Due to first and second barrier ribs 23a and 23b, discharge cells 18 are made in a form of two-dimensional array, and cross talk between the adjacent discharge cells can be effective prevented. Alternatively, barrier rib 23 can include only one of first barrier ribs 23a or second barrier ribs 23b, which are formed in a stripe structure.

In the embodiment of the present invention, as shown in FIG. 2, each of discharge cells 18 has a substantially rectangular shape when viewed from the top or bottom. In other words, each of discharge cells 18 has a shape of a rectangular parallelepiped, of which upper portion is open. Red, green, and blue phosphor layers 25 are formed in three groups of discharge cells 18, respectively, so that visible light with red, green, and blue colors can be generated. Each of red, green, and blue phosphor layers 25 is formed by coating the bottoms of discharge cells 18 and side surfaces of barrier ribs 23 with phosphors of red, green, and blue, respectively. Discharge cells 18 are filled with a discharge gas such as xenon (Xe) and neon (Ne).

In order to generate a plasma discharge in discharge cells 18, address electrodes 15, first electrodes 32 (hereinafter, referred to as sustain electrodes), and second electrodes 34 (hereinafter, referred to as scan electrodes) are formed on an inner surface of front substrate 10. Electrodes 15, 32, and 34 are provided on the top of each of discharge cells 18. First substrate 10 further includes first dielectric layer 12 formed on address electrodes 15, second dielectric layer 14 formed to enclose first electrodes 32 and second electrodes 34, and passivation film 13 formed on first dielectric layer 12 and second dielectric layer 14. Each of address electrodes 15 has extension 15a and protrusion 15b.

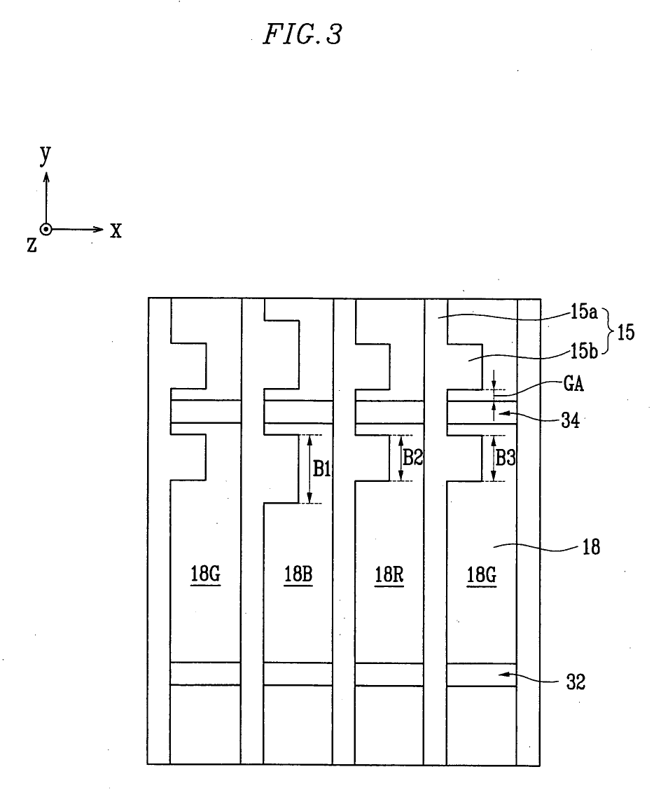

FIG. 3 is a plan view showing an arrangement of discharge cells and address electrodes shown in FIG. 2. Referring to FIG. 3, address electrodes 15 are disposed on the inner surface of front substrate 10 extending in the first direction (along Y-axis), and are parallel to each other. Each of address electrodes 15 are arranged on the top of discharge cells 18 that are arrayed along the address electrode. Discharge cells 18 includes red discharge cells 18R, green discharge cells 18G, and blue discharge cells 18B, which are designed to generate red, green, and blue colors, respectively. As shown in FIG. 3, red discharge cells 18R, green discharge cells 18G, and blue discharge cells 18B are arranged one by one in a second direction (along X-axis).

Each of address electrodes 15 includes extension 15a, which is arranged along first barrier rib 23a, and protrusion 15b, which is formed to protrude from extension 15a toward inside of one of discharge cells 18. Therefore, when viewed from the top, protrusion 15b is formed on the top of one of discharge cells 18. As described above, extension direction of address electrode is a first direction (along Y-axis), and therefore, extension direction of extension 15a is defined as the same as the extension direction of address electrode. Protrusion direction of protrude 15b is defined as perpendicular to the extension direction of extension 15a. A width of protrusion 15b is defined as a size of a side of protrusion 15b along the extension direction of extension 15a. In other words, a width of protrusion 15b is a size of a side perpendicular to the protrusion direction of protrusion 15b, as marked as B 1, B2, or B3 in FIG. 3. If protrusion 15b has a shape other than a rectangle, the width is defined as an average size over a side perpendicular to the protrusion direction of protrusion 15b.

As shown in FIG. 3, width Bi of protrusion 15b of address electrode, which is formed along blue discharge cells 18B, can be formed to be larger than widths B2 and B3, which are widths of protrusions 15b of address electrodes formed along red discharge cells 18R and green discharge cells 18G, respectively.

Extension 15a of each address electrodes 15 is disposed to extend along a boundary of red discharge cells 18R, green discharge cells 18G, or blue discharge cells 18B. In other words, extension 15a is disposed to extend in the first direction parallel to first barrier ribs 23a. Protrusion 15b is disposed to protrude in the second direction so as to select discharge cell 18R, 18G, or 18B. In addition, protrusion 15b is disposed near one of scan electrodes 34, which are disposed crossing discharge cells 18R, 18G, and 18B.

Protrusions 15b can be formed in various shapes. In FIG. 3, for example, protrusion 15b has a rectangular shape. Address voltage is applied between protrusions 15b of address electrode and scan electrodes 34, so that address discharge is generated in the selected discharge cell. As described above, width B1 of protrusion 15b corresponding to blue discharge cell 18B is designed to be larger than widths B2 and B3 of protrusions 15b corresponding to red and green discharge cells 18R and 18G. Blue discharge cells 18B have lower brightness than red and green discharge cells 18R and 18G, and deterioration of blue discharge cells 18B severer than red and green discharge cells 18R and 18G. Therefore, by designing blue discharge cells 18B to have protrusions 15b with larger width, the brightness of the blue discharge cell 18B can be improved, and lifespan of blue discharge cell 18B can be made even with red and green discharge cells 18R and 18G.

In addition, a pair of protrusions 15b can be disposed on both sides of each of scan electrodes 34. Alternatively, each of protrusions 15b can be disposed in each of scan electrodes 34. In any cases, each of scan electrodes 34 is shared by adjacent discharge cells 18 that are arranged along the first direction. Protrusion 15b corresponding to a discharge cell and shared scan electrode takes part in an address discharge of the discharge cell.

Address electrodes 15 are formed on the inner surface of front substrate 10 by a thin film of Cr/Cu/Cr, Cr/Al, Cr/Al/Cr, and metal insulator hybrid layer (MIHL) with a thickness of about 5 μm or less. By forming address electrodes 15 in a thin film, it is possible to solve the problems of the contemporary plasma display panels having thick address electrodes. In other words, disconnection of the electrodes due to narrow widths of electrodes of plasma display panels having high resolution and highly fine structure can be prevented. Moreover, electrical short between electrodes due to remaining particles of electrode material after a sintering process can be prevented. Therefore, it is possible to reduce a ratio of defective products.

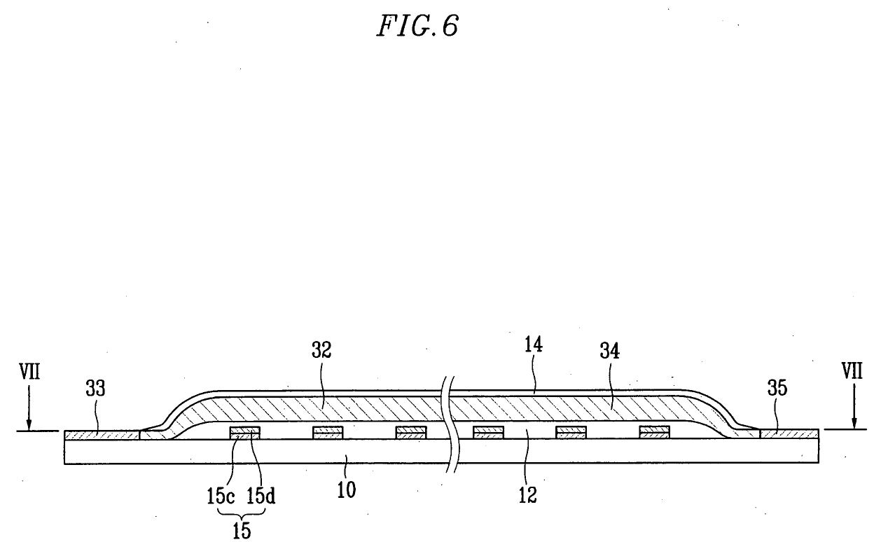

In particular, in a case where address electrodes 15 are made of MIHL, a transparent insulating material such a nitride film and an oxide film, and a metallic material are formed to have a gradient of concentration, so that a black layer 15c (shown in FIG. 6) is formed on an interface of address electrode 15 and front substrate 10. As a result, reflection of external light can be prevented. In addition, reflectance of visible light can be increased by staking white layer 15d (shown in FIG. 6) on black layer 15c, so that it is possible to improve a contrast ratio.

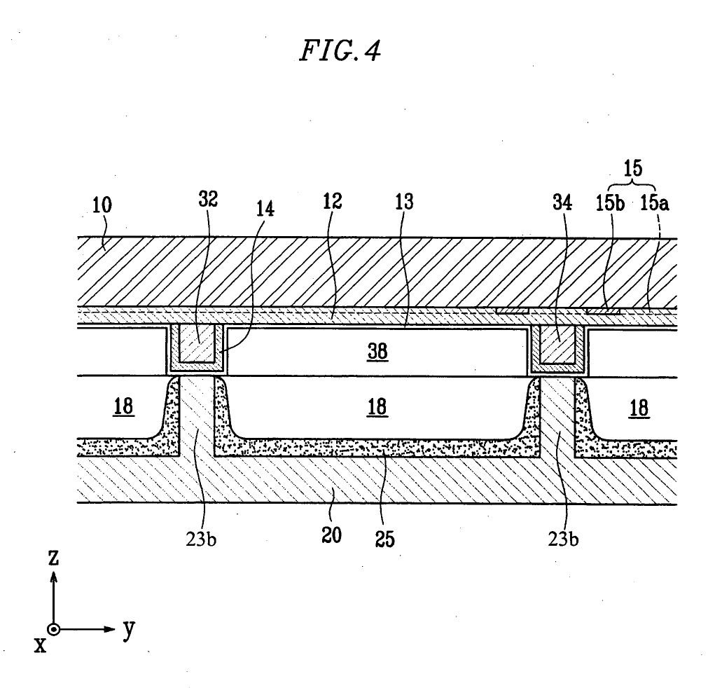

FIG. 4 is a side cross-sectional view taken along line IV-IV of FIG. 2. Referring to FIG. 4, first dielectric layer 12 is formed on the entire inner surface of front substrate 10 to cover address electrodes 15, more specifically, extensions 15a and protrusions 15b of address electrodes 15. First dielectric layer 12 generates and stores wall charges at the time of the plasma discharge, and electrically insulates address electrodes 15, sustain electrodes 32, and scan electrode 34 against charges generated in discharge space.

Sustain electrodes 32 and scan electrodes 34 are formed on first dielectric layer 12 of front substrate 10 extending in a second direction (along X-axis). Sustain electrodes 32 and scan electrodes 34 are disposed alternately along the first direction, with one of discharge cells 18 formed between sustain electrodes 32 and scan electrodes 34, to form an opposite-discharge structure where sustain electrodes 32 and scan electrodes 34 face each other.

Each of sustain electrodes 32 and each of scan electrodes 34 have predetermined line widths, and extend in a third direction (along Z-axis) from the surface of dielectric layer 12 to form thicknesses of sustain electrodes 32 and scan electrodes 34. The thickness of sustain electrodes 32 and scan electrodes 34 is about 50 μm to 100 μm, which is larger than the thickness of address electrode 15. Sustain electrodes 32 and scan electrodes 34 are covered with a second dielectric layer 14.

Sustain electrodes 32 and scan electrodes 34 are aligned to second barrier ribs 23b, and are disposed alternately in the first direction. Each of sustain electrodes 32 and each of scan electrodes 34 are disposed to face each other across a discharge cell, so that the sustain electrode and the scan electrode take part in sustain discharge of the discharge cell.

A facing area of sustain electrodes 32 is an area of a surface of sustain electrodes 32 that faces a surface of scan electrodes 34, and a facing area of scan electrodes 34 is an area of a surface of scan electrodes 34 that faces the surface of sustain electrodes 32. In this structure, the facing areas of sustain electrodes 32 and scan electrodes 34 are designed to be wide, and therefore, substrate electrodes 32 and scan electrodes 34 are formed in the opposite discharge type in discharge cells 18, so that more stronger vacuum ultra violet rays can be generated. The strong vacuum ultra violet rays collide with phosphor layers 25 in discharge cells 18, so that the intensity of the visible light can be increased.

On the other hand, in the address discharge period, address voltages are applied to address electrodes 15, including extension 15a and protrusion 15b, and scan voltages are applied to scan electrodes 34, so that discharge cells 18 to be turned on are selected during the address discharge. In the sustain period, sustain voltages are applied between sustain electrodes 32 and scan electrodes 34, so that sustain discharges are generated in selected discharge cells 18 that can implement an image. The voltage pulses applied to the electrodes can be suitably selected as needed.

Scan electrodes 34 are disposed near protrusion 15b of address electrodes 15 in order to easily generate address discharge between address electrodes 15 and scan electrodes 34. each of scan electrode 34 is also aligned parallel to second barrier ribs 23b, and accordingly, scan electrodes 34 take part in the address discharge of a pair of discharge cells 18 adjacent to the scan electrode.

Since address electrodes 15 and scan electrodes 34 are formed on front substrate 10, one of scan electrodes 34 and protrusion 15b of address electrodes 15, where an address discharge is substantially generated, are disposed to be adjacent to each other with a discharge gap (GA), which is a distance between the scan electrode and the protrusion. Therefore, it is possible to generate the address discharge with a low voltage.

Second dielectric layer 14 is disposed to surround sustain electrodes 32 and scan electrodes 34, so that discharge space 38 of each of discharge cells 18 includes the space formed between sustain electrode 32 and scan electrode 34. Discharge spaces 38 is included in discharge cell 18. Second dielectric layer 14 is formed in a form of two-dimensional array aligned to first and second barrier ribs 23a and 23b. Therefore, each of discharge cells 18 is completely enclosed by second dielectric layer 14, and first and second barrier ribs 23a and 23b. Passivation film 13 made of magnesium oxide (MgO) can be formed on first dielectric layer 12 and on second dielectric layer 14.

In the plasma display panel of the present invention, protrusion 15b of address electrodes 15 and scan electrodes 34 are disposed to correspond to a pair of discharge cells 18 adjacent to each other in the first direction, odd-numbered lines and even-numbered lines can be separately driven. As an example of such a driving method, the odd-numbered lines and the even-numbered lines of sustain electrodes 32 and scan electrodes 34 are separately driven. More specifically, when the odd-numbered lines are driven, voltages are applied to only sustain electrodes 32 and scan electrodes 34 of odd-numbered lines. When the even-numbered lines are driven, voltages are applied to only sustain electrodes 32 and scan electrodes 34 of the even-numbered lines.

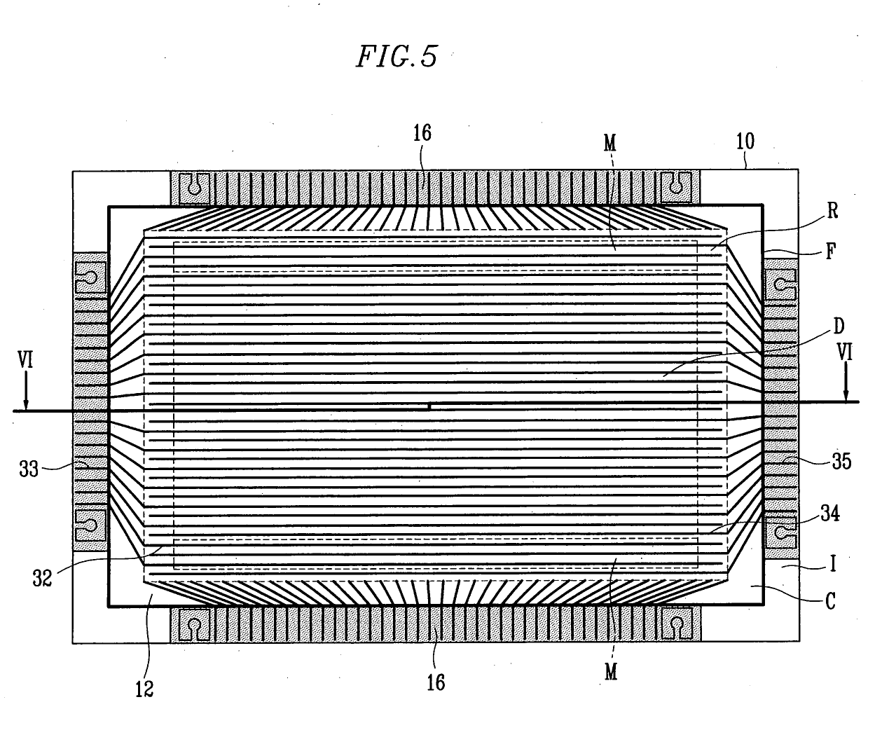

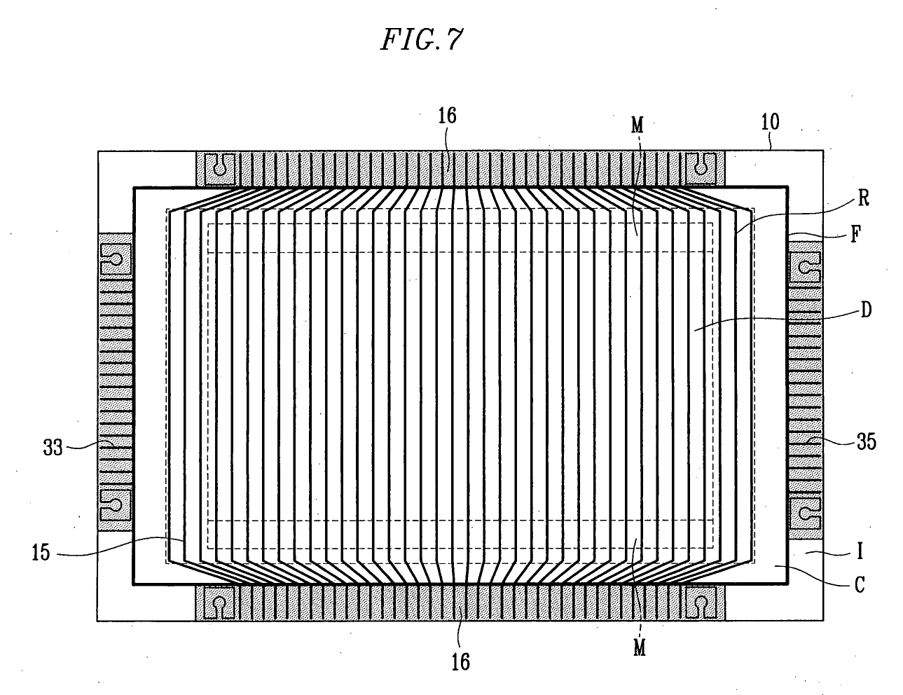

FIG. 5 is a plan cross-sectional view taken along line V-V of FIG. 1. FIG. 6 is a side cross-sectional view taken along line VI-VI of FIG. 5. FIG. 7 is a plan view showing the plasma display panel where a dielectric layer is removed along line VII-VII of FIG. 6. Referring to FIGS. 5 to 7, in the plasma display panel constructed as the embodiment of the present invention, dummy region M, redundant region R, port connection region C, and display region D for generating an image are further disposed in a space enclosed by frit F, which seals the space between front substrate 10 and rear substrate 20. Ports 16, 33, and 35 are formed on interconnection region I, which is outside of frit F of front substrate 10. First (sustain) port 33 is connected to sustain electrodes 32, second (scan) port 35 is connected to scan electrodes 34, and address port 16 is connected to address electrodes 15

Dummy region M is disposed outside display region D. Dummy region M is additional display region for displaying an image, size of which is larger than a display format. Dummy region M is used so as to prevent an edge effect as discharge irregularity which may occur in the outermost discharge cell of display region D.

Redundant region R is disposed outside dummy region M. Redundant region R is used so as to complement an alignment error and an accuracy limit in the course of the processes for stacking layers.

Port connection region C provide a space to smoothly connect address electrodes 15, sustain electrodes 32, and scan electrodes 34 to ports 16, 33, and 35 of interconnection region I, respectively. Therefore, severe deformation of electrodes are prevented.

Interconnection region I is a region where ports 16, 33, and 35 are formed. Ports 16, 33, and 35 are connected to connectors of FPC, COF, and TCP to apply driving voltages from a driving circuit to address electrodes 15, sustain electrodes 32, and scan electrodes 34 for driving the plasma display panel.

In the embodiment of the present invention, address port 16, first port 33, and second port 35 are electrically connected to address electrodes 15, sustain electrode 32, and scan electrode 34, respectively. First port 33 is disposed on a first edge of the inner surface of front Isubstrate 10, second port 35 on a second edge of the inner surface of front substrate 10, and address port 16 on third edge of the inner surface of front substrate 10. Address port 16, first port 33, and second port 35 are separately disposed on edges of the inner surface of front substrate 10 which are exposed beyond rear substrate 20. Address port 16 of address electrodes 15 are disposed on both opposite edges of front substrate 10. As shown in FIG. 5, port 16 of address electrodes 15 are disposed on the upper and lower side edges of front substrate 10. However, the present invention is not limited thereto. Port 16 of address electrodes 15 can be disposed on only one of the upper and lower side edges of front substrate 10.

First ports 33 of sustain electrode 32 is disposed on one side (first edge) of front substrate 10, and second port 35 of scan electrode 34 is disposed on the other side (second edge) of front substrate 10 . As shown in FIG. 5, port 33 is formed on the left side of front substrate 10, and port 35 is formed on the right side of front substrate 10

Since port 16 of address electrodes 15, port 33 of sustain electrodes 32, and port 35 of scan electrodes 34 are disposed on the same substrate, a number of processes for manufacturing the plasma display panel can be reduced, so that it is possible to improve productivity.

Port 16 of address electrodes 15, port 33 of sustain electrodes 32, and ports 35 of scan electrodes 34 are constructed by forming a thin film made of Cr/Cu/Cr, Cr/Al, Cr/Al/Cr, or MIHL (metal insulator hybrid layer) with a thickness of about 5 μm or less on front substrate 10. Since ports 16, 33, and 35 are formed with the thin film, it is possible to reduce electrical short between the ports and defects for connection to connectors of FPC, COF, and TCP.

As shown in FIG. 5, sustain electrode 32 and scan electrodes 34 are alternately disposed on first dielectric layer 12 of front substrate 10 extending to redundant region R in the second direction. In port connection region C, sustain electrodes 32 and scan electrodes 34 are bent smoothly with predetermined angles to be connected to port 33 of sustain electrodes 32 and port 35 of scan electrodes 34, respectively.

The thickness of each of sustain electrodes 32 and scan electrodes 34 is in a range of about 50 μm to 100 μm, and the thickness of each of ports 32 and 35 is about 5 μm or less. Therefore, as shown in FIG. 6, thickness of each of sustain electrodes 32 and scan electrode 34 gradually decreases for connection to ports 33 and 35 in port connection region C.

As shown in FIG. 7, address electrodes 15 are formed in parallel to each other on front substrate 10 extending to redundant region R in the first direction. In port connection region C, address electrodes 15 are bent smoothly with predetermined slant angles with the same thickness to be connected to port 16 of address electrodes 15.

In a plasma display panel of the present invention, display electrodes having an opposite-discharge electrode structure are formed on the same substrate where address electrodes are formed, so that it is possible to improve discharge efficiency of the plasma display panel. In addition, the address electrode, ports of the address electrode, and ports of the display electrodes are constructed by forming thin films on the same substrate. Therefore, it is possible to improve productivity and production yield.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A plasma display panel comprising:
a first substrate;
a second substrate facing the first substrate and spaced apart from the first substrate;
a plurality of discharge cells formed in a space between the first substrate and the second substrate by partitioning the space, the discharge cells including red discharge cells, green discharge cells, and blue discharge cells;
a plurality of address electrodes formed on the first substrate and extending in a first direction;
a plurality of first electrodes formed on the first substrate and extending in a second direction that is substantially perpendicular to the first direction;
a plurality of second electrodes formed on the first substrate and extending in the second direction; each of the first electrodes facing one of the second electrodes, one of the discharges cells being disposed between the each of the first electrodes and the one of the second electrodes;
a first port formed on a first edge of the first substrate, the first port being connected to the first electrodes;
a second port formed on a second edge of the first substrate, the second port being connected to the second electrodes;
an address port formed on a third edge of the first substrate, the address port being connected to the address electrodes; and
a red phosphor layer formed in each of red discharge cells, a green phosphor layer formed in each of green discharge cells, and a blue phosphor layer formed in each of blue discharge cells.

2. The plasma display panel of claim 1, wherein at least three edges of the first substrate are exposed beyond the second substrate.

3. The plasma display panel of claim 1, wherein the third edge of the first substrate is parallel to the second direction.

4. The plasma display panel of claim 1, wherein the first edge and the second edge of the first substrate are parallel to the first direction.

5. The plasma display panel of claim 1, wherein each of the address port, the first port, and the second port are made one selected from the group consisting of chromium-copper-chromium (Cr/Cu/Cr), chromium-aluminum (Cr/Al), chromium-aluminum-chromium (Cr/Al/Cr), and metal insulator hybrid layer (MIHL).

6. The plasma display panel of claim 1, wherein the thickness of the address electrodes is the same as the thickness of the address port.

7. The plasma display panel of claim 6, wherein the address electrodes are formed of one selected from the group consisting of chromium-copper-chromium (Cr/Cu/Cr), chromium-aluminum (Cr/Al), chromium-aluminum-chromium (Cr/Al/Cr), and metal insulator hybrid layer (MIHL).

8. The plasma display panel of claim 6, wherein each of the address electrodes comprises:
a black layer contacting the first substrate to prevent reflection of light; and
a white layer formed on the black layer to reflect light.

9. The plasma display panel of claim 1, wherein each of the address electrodes comprises:
an extension extending in the first direction; and
a plurality of protrusions protruding from the extension in the second direction, each of the protrusions aligned on a top of one of the discharge cells.

10. The plasma display panel of claim 9, wherein a width of the protrusions aligned on the top of one of the blue discharge cells is larger than a width of the protrusions aligned on the top of red discharge cells, and is larger than a width of the protrusions aligned on the top of green discharge cells.

11. The plasma display panel of claim 1, wherein the thickness of the first electrodes is larger than the thickness of the first port, and the thickness of the second electrodes is larger than the thickness of the second port

12. A plasma display panel comprising:
a first substrate;
a second substrate facing the first substrate and spaced apart from the first substrate;
a plurality of discharge cells formed in a space between the first substrate and the second substrate by partitioning the space, the discharge cells including red discharge cells, green discharge cells, and blue discharge cells;
a plurality of address electrodes formed on an inner surface of the first substrate and extending in a first direction;
a first dielectric layer formed on the inner surface of the first substrate and covering the address electrodes;
a plurality of first electrodes formed on the first dielectric layer and extending in a second direction that is substantially perpendicular to the first direction;
a plurality of second electrodes formed on the first dielectric layer and extending in the second direction; each of the first electrodes facing one of the second electrodes, one of the discharges cells being disposed between the each of the first electrodes and the one of the second electrodes;
a second dielectric layer covering the first electrodes and the second electrodes; and
a red phosphor layer formed in each of red discharge cells, a green phosphor layer formed in each of green discharge cells, and a blue phosphor layer formed in each of blue discharge cells.

13. The plasma display panel of claim 12, wherein the address electrodes are formed of one selected from the group consisting of chromium-copper-chromium (Cr/Cu/Cr), chromium-aluminum (Cr/Al), chromium-aluminum-chromium (Cr/Al/Cr), and metal insulator hybrid layer (MIHL).

14. The plasma display panel of claim 13, wherein each of the address electrodes comprises:
a black layer contacting the first substrate to prevent reflection of light; and
a white layer formed on the black layer to reflect light.

15. The plasma display panel of claim 12, wherein each of the address electrodes comprises:
an extension extending in the first direction; and
a plurality of protrusions protruding from the extension in the second direction, each of the protrusions aligned on a top of one of the discharge cells.

16. The plasma display panel of claim 15, wherein a width of the protrusions aligned on the top of one of the blue discharge cells is larger than a width of the protrusions aligned on the top of red discharge cells, and is larger than a width of the protrusions aligned on the top of green discharge cells.
